(19) United States
(12) Patent Application Publication
(10) Pub. No.: US 2026/0238907 A1
(43) Pub. Date: Aug. 13, 2026

(54) OPTICAL MODULE ACCESS METHOD, APPARATUS AND SYSTEM, ELECTRONIC DEVICE, AND NONVOLATILE READABLE STORAGE MEDIUM

(71) Applicant: SUZHOU METABRAIN INTELLIGENT TECHNOLOGY CO., LTD., Suzhou, Jiangsu (CN)

(72) Inventors: Jinyou WANG, Suzhou, Jiangsu (CN); Wei HAN, Suzhou, Jiangsu (CN); Guangying XUE, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/469,592

(22) PCT Filed: Nov. 15, 2024
(86) PCT No.: PCT/CN2024/132405

§ 371 Date: Oct. 6, 2025

(30) Foreign Application Priority Data
Nov. 15, 2023 (CN) 202311517868.4

(51) Int. Cl. H04Q 11/00; H04B 10/278

(52) U.S. Cl. CPC H04Q 11/0067; H04B 10/278; H04Q 2011/0081; H04Q 2011/009

(57) ABSTRACT

An optical module access method, system, and an electronic device, which are applied to the technical field of computers, is provided. The system includes a Central Processing Unit (CPU), and an interface function extension structure including a plurality of programmable logic controllers; and the CPU is connected with a port of each of the plurality of programmable logic controllers via a target bus. The CPU issues an optical module access request to the interface function extension structure via the target bus. Each of the programmable logic controllers is connected with a plurality of optical modules via a plurality of Inter-Integrated Circuit (I2C) buses, accesses a target optical module according to an optical module address carried in the optical module access request, and performs information feedback to the CPU by means of interrupt multiplexing.

### CROSS-REFERENCE TO RELATED APPLICATIONS

This application is a National Stage Entry under 35 U.S.C. § 371 of PCT International Application No. PCT/CN 2024/132405, filed on Nov. 15, 2024, which claims priority to Chinese Patent Application No. 202311517868.4 filed to the China National Intellectual Property Administration on Nov. 15, 2023 and entitled “Optical Module Access Method, Apparatus and System, and Electronic Device and Readable Storage Medium”, the entire contents of each of which are incorporated herein by reference for all purposes.

### TECHNICAL FIELD

The present disclosure relates to the technical field of computers, and in particular, to an optical module access method, a system, and an electronic device.

### BACKGROUND

With the rapid development of data center services, the demand for data center switches, exchange capacities of the switches, panel port data, and port rates have also gradually increased, requiring frequent access to an optical module.

An Inter-Integrated Circuit (I2C) interface of a Central Processing Unit (CPU) is used in the related art, and access to the optical module is achieved through cascading of external multi-level I2C extension chips. However, the I2C interface of the CPU itself is only configured to achieve simple communications, and not process complex I2C communications; and there are I2C interfaces, leading to low access efficiency of the optical module.

### SUMMARY

The present disclosure provides an optical module access method, a system, and an electronic device, such that an optical module may be accessed efficiently.

In order to solve the above technical problem, the present disclosure provides the following technical solutions.

An aspect of the present disclosure provides an optical module access system, including a Central Processing Unit (CPU) and an interface function extension structure, wherein
the interface function extension structure includes a plurality of programmable logic controllers, and the CPU is connected with a port of each of the plurality of programmable logic controllers via a target bus;
the CPU is configured to issue an optical module access request to the interface function extension structure via the target bus; and
each of the plurality of programmable logic controllers of the interface function extension structure is connected with a plurality of optical modules via a plurality of Inter-Integrated Circuit (I2C) buses, and is configured to access a target optical module according to an optical module address carried in the optical module access request, and to perform information feedback to the CPU by means of interrupt multiplexing.

In a first exemplary implementation, a programmable logic controller includes a bus salve interface module, an address allocation module, a register processing module, a communication control module, and an interrupt module;
the address allocation module is connected with the bus salve interface module, the register processing module, and the communication control module, respectively; the interrupt module is connected with the CPU and the communication control module, respectively;
the bus salve interface module is configured to analyze read and write commands of the target bus, and convert analyzed read and write commands into read and write commands in a target format; the address allocation module is configured to allocate addresses to the communication control module and the register processing module; the register processing module is configured to perform read and write processing on each of registers in a process of accessing the optical module; the communication control module is configured to control a time sequence in the process of accessing the optical module; and the interrupt module is configured to perform information reporting to the CPU by means of interrupt multiplexing.

In a second exemplary implementation, the communication control module includes a register interface, a byte control module, a bit control module, and a clock division module;
the register interface is connected with the byte control module, the bit control module, and the clock division module, respectively; the byte control module is connected with the bit control module; the clock division module is connected with the bit control module; the bit control module is connected with I2C buses;
the register interface is configured to complete a generation of reading, writing and interruption of the registers in the process of accessing the optical module; the byte control module is configured to control a start bit command and a stop bit command in the process of accessing the optical module, and split a data bit command and a response bit command; the bit control module is configured to complete a sending time sequence and a receiving time sequence of each of commands; and the clock division module is configured to divide a high-frequency clock into target I2C clock signals, and send the target I2C clock signals to the bit control module.

In a third exemplary implementation, the byte control module is configured to control the start bit command and the stop bit command by controlling a state machine to be in different states, and to split the data bit command and the response bit command.

In a fourth exemplary implementation, the byte control module is further configured to:
in a case where a current state of the state machine is not an idle state, jump to a stop bit state in response to receiving the stop bit command;
in response to receiving the start bit command, jump to a start bit state, and perform a corresponding byte operation until a target bit is operated, and simultaneously jump to a response bit state; in a case where a response is completed, jump to the stop bit state; and in a case where the response is not completed, jump to the idle state.

In a fifth exemplary implementation, the byte control module is configured to enter a read bit state in response to receiving an optical module information reading command, and simultaneously count a total number of read bits; and jump to the response bit state in response to detecting a current total number of read bits to reach the target bit.

In a sixth exemplary implementation, the byte control module is configured to enter a write bit state in response to receiving an optical module information write command, and simultaneously count a total number of write bits; and jump to the response bit state in response to detecting a current total number of write bits to reach the target bit.

In a seventh exemplary implementation, the communication control module includes a plurality of control sub-modules; each of the plurality of control sub-modules is connected with the address allocation module and the interrupt module, respectively;
each of the plurality of control sub-modules is configured to access a corresponding optical module according to an optical module address carried in an optical module access request issued by the CPU, and to perform information feedback to the CPU by means of interrupt multiplexing.

In an eighth exemplary implementation, the target bus is a Low Pin Count (LPC) bus; and the bus salve interface module is configured to complete an IO read and write function of the LPC bus.

In a ninth exemplary implementation, the interface function extension structure is connected with each of the plurality of optical modules via an I2C extension chip device; two ends of the I2C extension chip device are respectively connected with the interface function extension structure and each of the plurality of optical modules via an I2C bus; and
a number of extension channels in the I2C extension chip device is determined based on a number of the plurality of programmable logic controllers included in the interface function extension structure and a total number of control sub-modules included in the communication control module, and each of the extension channels uniquely corresponds to one of the control sub-modules.

In a tenth exemplary implementation, the interface function extension structure includes a plurality of complex programmable logic devices; and
one end of each of the plurality of complex programmable logic devices is connected with the CPU via the target bus, and the other end is connected with the I2C extension chip device via an I2C bus.

In an eleventh exemplary implementation, the interface function extension structure is further configured to send a bus exception signal to the CPU in a case where an access exception is detected in an I2C bus connected with the target optical module.

In a twelfth exemplary implementation, the CPU is further configured to send a write command and a stop command to the target optical module, causing the target optical module to release the I2C bus.

In a thirteenth exemplary implementation, the interface function extension structure is further configured to send a write command and a stop command to the target optical module, causing the target optical module to release the I2C bus.

In a fourteenth exemplary implementation, the interface function extension structure is further configured to:
in response to being in an idle state, monitor whether an interrupt signal exists, and report a monitored interrupt signal to the CPU;
in response to detecting the interrupt signal, jump to an interrupt state; in response to being in the interrupt state, determine whether a current interrupt duration exceeds a preset interrupt threshold;
in response to determining that the current interrupt duration exceeds the preset interrupt threshold, jump to the idle state; in response to determining that the current interrupt duration does not exceed the preset interrupt threshold, jump to a response state;
in response to being in the response state, determine whether a current response time exceeds a preset response threshold;
in response to determining that the current response time exceeds the preset response threshold, jump to the idle state; and in response to determining that the current response time does not exceed the preset response threshold, jump to the idle state after the response is completed.

Another aspect of the present disclosure provides an optical module access method, which is applied to any one of the above optical module access systems, including:
receiving an optical module access request; and
accessing a target optical module according to an optical module address carried in the optical module access request, and performing information feedback by means of interrupt multiplexing.

As an exemplary implementation, accessing the target optical module according to the optical module address carried in the optical module access request includes:
determining a corresponding target extension channel in an Inter-Integrated Circuit (I2C) extension chip device based on the optical module address, and opening the target extension channel; and
acquiring a protocol format according to optical module information determined by an I2C communication protocol, sending an optical module information reading command, and closing the target extension channel after the optical module information is read.

As another exemplary implementation, opening the target extension channel includes:
sending a start bit; and
sending an I2C extension chip device address write command, and sending a write data command, to open the target extension channel.

As still another exemplary implementation, sending the optical module information reading command includes:
sending a start bit;
sending an optical module address read command and an optical module register read command;
sending the start bit; and
sending the optical module register read command and an optical module data read command.

As still another exemplary implementation, closing the target extension channel after the optical module information is read includes:
sending a stop bit command in a case that the optical module information is read;
sending a start bit; and
sending an I2C extension chip device address write command, and sending a write data 0 command, to close the target extension channel.
As still another exemplary implementation, accessing the target optical module according to the optical module address carried in the optical module access request includes:
determining a corresponding target extension channel in an I2C extension chip device based on the optical module address, and opening the target extension channel; and
acquiring a protocol format according to optical module information determined by an I2C communication protocol, sending an optical module information write command, and closing the target extension channel after the optical module information is written.

As still another exemplary implementation, sending the optical module information write command includes:
sending a start bit;
sending an optical module address read command and an optical module register write command; and
sending an optical module data write command.

Still another aspect of the present disclosure provides an optical module access apparatus, which is applied to any one of the above optical module access systems. The apparatus includes a request receiving module and an optical module access module.

The request receiving module is configured to receive an optical module access request.

The optical module access module is configured to access a target optical module according to an optical module address carried in the optical module access request, and perform information feedback by means of interrupt multiplexing.

The present disclosure further provides an electronic device, including a processor and a memory, and the processor is configured to, in response to executing a computer program stored in a memory, implement steps of any one of the above optical module access methods.

The present disclosure further provides a non-transitory readable storage medium ultimately. The non-transitory readable storage medium stores a computer program. The computer program, in response to being executed by a processor, implements steps of any one of the above optical module access methods.

It is to be understood that, the above general description and the following detailed description are merely exemplary, and cannot limit the present disclosure.

### BRIEF DESCRIPTION OF THE DRAWINGS

In order to more clearly illustrate the present disclosure or the technical solutions in the related art, the drawings used in the description of the embodiments or the related art will be briefly described below. It is apparent that the drawings in the following descriptions are merely some embodiments of the present disclosure. Other drawings can be obtained from those skilled in the art according to these drawings without any creative work.

FIG. 1 is a schematic diagram of an implementation structure framework of an optical module access system according to the present disclosure.

FIG. 2 is a schematic diagram of another implementation structure framework of an optical module access system according to the present disclosure.

FIG. 3 is a schematic diagram of an implementation structure framework of a communication control module according to the present disclosure.

FIG. 4 is a schematic flowchart of a state machine of a byte control module according to the present disclosure.

FIG. 5 is a schematic flowchart of interrupt multiplexing of an interrupt module according to the present disclosure.

FIG. 6 is a schematic structural diagram of an optical module access system of an exemplary application scenario according to the present disclosure.

FIG. 7 is a schematic flowchart of an optical module access method according to the present disclosure.

FIG. 8 is a structure diagram of an implementation of an optical module access apparatus according to the present disclosure.

FIG. 9 is a structure diagram of an implementation of an electronic device according to the present disclosure.

### DETAILED DESCRIPTION OF THE EMBODIMENTS

In order to make those skilled in the art better understand the technical solutions of the present disclosure, the present disclosure is further described in detail below with reference to the drawings and specific implementations. It is apparent that the described embodiments are only part of the embodiments of the present disclosure, not all the embodiments.

All other embodiments obtained by those of ordinary skill in the art on the basis of the embodiments in the present disclosure without creative work all fall within the scope of protection of the present disclosure. Terms “first”, “second”, “third”, “fourth”, and the like in the description, claims and the above mentioned drawings of the present disclosure are used for distinguishing different objects rather than describing a specific sequence. In addition, terms “include” and “have” and any variations thereof are intended to cover non-exclusive inclusions. The term “exemplary” refers to “use as an example, embodiment, or description”. Herein, any “exemplarily” described embodiment may not be explained to be superior to or better than other embodiments.

Currently, the manner of a data center to acquire port state information is to use a Baseboard Management Controller (BMC) with many I2C ports to perform optical module management or use an I2C port of a CPU to externally mount a multi-level I2C extension chip to realize optical module access. However, for a client without requirements for the BMC, the optical module management can only be placed on the CPU side, and the I2C interfaces of the CPU is limited, and is only configured to achieve a simple communication without processing complex I2C communications. Multi-level I2C extension chip cascading or dedicated chips are mostly used in the related art to achieve optical module management, leading to low efficiency and high costs. In the present disclosure, on the basis of original hardware, an optical module management interface is connected with a port of the interface function extension structure via the target bus, and I2C extension is realized by using the interface function extension structure, such that software and hardware extension may be flexibly performed according to the number of the ports, thereby achieving low-cost and efficient optical module access. The following describes in detail various non-limiting embodiments of the present disclosure. For describing the present disclosure better, many details are presented in the following implementations. It is understood by those skilled in the art that the present disclosure may still be implemented even without these details. In some other examples, methods, means, components and circuits known very well to those skilled in the art are not described in detail, so as to highlight the subject of the present disclosure.

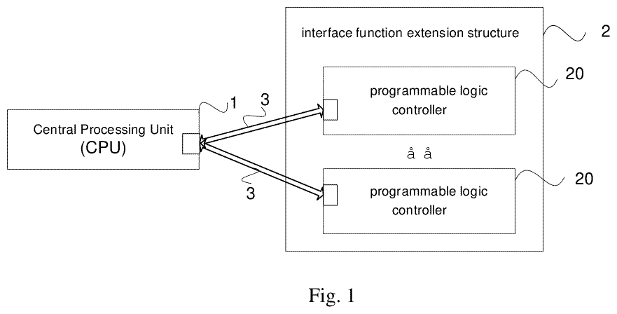

First, referring to FIG. 1, FIG. 1 is a schematic diagram of a structure framework of an optical module access system in an implementation according to the present disclosure. The present disclosure may include the following content.

An optical module access system may include a CPU 1 and an interface function extension structure 2, where the CPU 1 as a processor. The interface function extension structure 2 includes a plurality of programmable logic controllers 20, where a programmable logic controller 20 as a controller, and the CPU 1 is connected with a port of each of the programmable logic controllers via a target bus 3. The target bus 3 may be any bus that can connect the CPU 1 and each of the programmable logic controllers, and the target bus 3 may be an Enhanced Serial Peripheral Interface (eSPI) bus or an LPC bus, and the present disclosure is not limited thereto. In order to achieve low-cost access to the optical module, the target bus in this embodiment may be the LPC bus. A total number of the programmable logic controllers 20 included in the interface function extension structure 2 may be determined according to a total number of the optical modules in an actual application scenario and the performance of software and hardware in the system. The programmable logic controller 20 may be any type of programmable hardware. In order to achieve low-cost access to the optical module, the programmable logic controller 20 in this embodiment may be a Complex Programmable Logic Device (CPLD), for example, a programmable logic device that may be based on a Complementary Metal Oxide Semiconductor (CMOS) technology and field programmable flash technology, for example, an XC9536XL-10PCG44C chip (chip model), which may be flexibly selected based on actual situations by those skilled in the art. One end of each complex programmable logic device is connected with the CPU 1 via the target bus 3, and the other end is connected with the I2C extension chip device via the I2C bus. The I2C extension chip device may divide the I2C bus into a plurality of sub-buses, and each sub-bus may support a plurality of I2C devices, that is, the interface function extension structure 2 may be connected with a plurality of optical modules through the I2C extension chip device, thereby realize access to the optical module.

In this embodiment, the CPU 1 is configured to issue an optical module access request to the interface function extension structure 2 via the target bus 3. The optical module access request includes an optical module information query or acquisition request, and may also include an optical module information writing request. After receiving the optical module access request of an upper-level software or a client, the CPU 1 issues the optical module access request to the interface function extension structure 2 for processing. Each of the programmable logic controllers 20 of the interface function extension structure 2 is connected with each of the plurality of optical modules via a plurality of I2C buses and optical ports, and each of the plurality of I2C buses may be connected with one of the optical ports. An optical port is an interface for transmitting optical signals, which includes, but is not limited to, a Small Form-factor Pluggable (SFP) or a Quad Small Form-factor Pluggable (QSFP), and is configured to access a target optical module according to an optical module address carried in the optical module access request based on an I2C communication protocol, and perform information feedback to the CPU 1 by means of interrupt multiplexing. Information feedback may include reporting, to the CPU, fault information, as well as processing progress information of the optical module access request.

In the technical solutions configured in the present disclosure, on the basis of original hardware, an optical module management interface is connected with a port of the interface function extension structure via the target bus, and I2C extension is realized by using the interface function extension structure, such that software and hardware extension may be flexibly performed according to the number of the ports, thereby achieving efficient optical module access. Overall hardware modification is small, hardware design topology is simple, and logical reusability is good, such that logic hardware development costs may be effectively reduced. Data reporting is performed by means of interrupt multiplexing, such that software resource utilization may be reduced from the original 90% to below 4%, and only upper-level driver needs to be slightly adjusted, such that development complexity and design difficulty are reduced, development risks are reduced, the reliability of the system is improved, and costs are effectively reduced, thereby achieving low-cost and efficient access to the optical module.

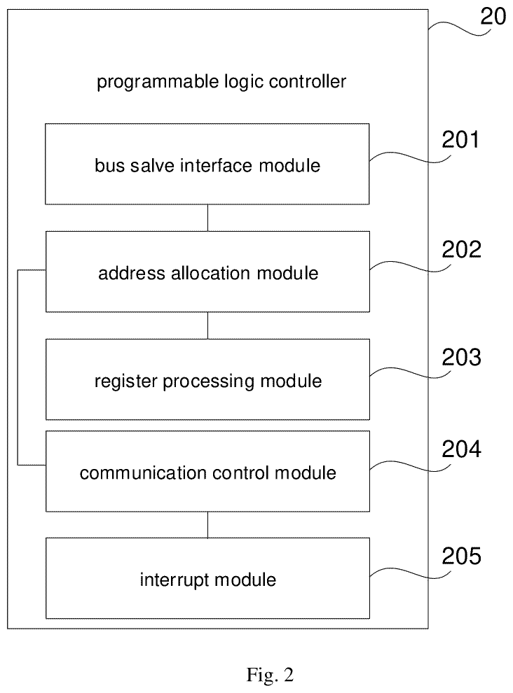

An internal structure of each programmable logic controller 20 of the interface function extension structure 2 is not limited in the above embodiments. Based on this, the present disclosure further provides an implementation, which may include, referring to FIG. 2, the following content. In this embodiment, a programmable logic controller 20 includes a bus salve interface module 201, an address allocation module 202, a register processing module 203, a communication control module 204, and an interrupt module 205. The bus salve interface module 201, the address allocation module 202, the register processing module 203, the communication control module 204, and the interrupt module 205 are all program modules in the programmable logic controller 20 to achieve specific functions, that is, the bus salve interface module 201, the address allocation module 202, the register processing module 203, the communication control module 204, and the interrupt module 205 are a series of computer program instruction sections that can complete specific functions. In terms of data interaction or data flow, one end of the address allocation module 202 is connected with the bus salve interface module 201, and the other end is connected with the register processing module 203 and the communication control module 204, respectively; and the interrupt module 205 is also connected with the CPU 1 and the communication control module 204, respectively.

The bus salve interface module 201 is configured to read and write the target bus 3, analyze read and write commands of the target bus, convert the analyzed read and write commands into read and write commands in a target format, and perform data interaction on a corresponding register according to current read and write requirements, that is, the bus salve interface module 201 matches the target bus 3, the target bus 3 is an LPC, and the bus salve interface module 201 is an LPC salve interface module and is configured to complete the IO read and write functions of the LPC bus. The address allocation module 202 is configured to allocate addresses to the communication control module 204 and the register processing module 203, that is, the address allocation module allocates addresses to the registers and the communication control module 204 involved in the process of accessing the optical module. The register processing module 203 is configured to perform read and write processing on each of registers in a process of accessing the optical module, for example, reading and writing for an interrupt register, a reset register, or a test register. The communication control module 204 is configured to control, based on the I2C communication protocol, a time sequence in the process of accessing the optical module, for example, completing time sequence control of a start bit, a data bit, and a stop bit specified by the I2C communication protocol. The interrupt module 205 is configured to perform information reporting to the CPU by means of interrupt multiplexing. The interrupt module completes operations of the communication control module 204. In a case where the communication control module 204 includes a plurality of branches to control, based on the I2C communication protocol, the time sequence in the process of accessing the optical module, the reporting and interrupt timeout processing of an interrupt signal of each branch may be completed.

From the above, it may be learned that, in this embodiment, through the program modules of the bus salve interface module, the address allocation module, the register processing module, the communication control module, and the interrupt module for achieving specific functions, the entire process from receiving the optical module access request to accessing the optical module is completed, achieving simple implementation, and facilitating reduction of costs, thereby realizing low-cost access to the optical module.

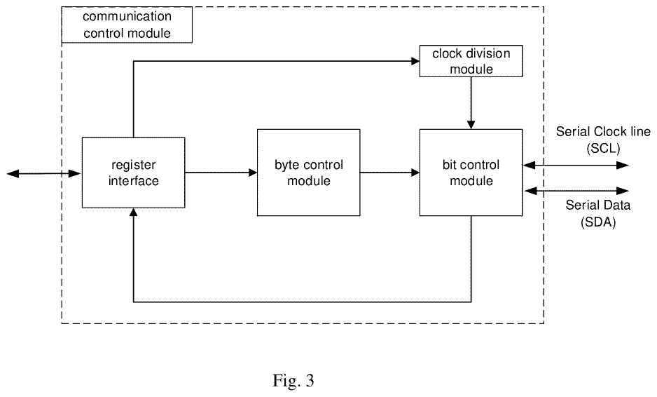

The control of the time sequence in the process of accessing the optical module based on the I2C communication protocol is not limited in the above embodiments. Based on the above embodiments, the present disclosure further provides another embodiment, which may include, referring to FIG. 3, the following content.

The communication control module 204 may include a register interface, a byte control module, a bit control module, and a clock division module. The register interface, the byte control module, the bit control module, and the clock division module all are program modules in the programmable logic controller 20 to achieve specific functions, that is, the register interface, the byte control module, the bit control module, and the clock division module are a series of computer program instruction sections that can complete the specific functions. In terms of data interaction or data flow, one end of the register interface is connected with the address allocation module, and the other end is connected with the byte control module, the bit control module, and the clock division module, respectively. The byte control module is connected with the bit control module. The clock division module is connected with the bit control module to transmit clock signals to the bit control module. The bit control module is connected with I2C buses, that is, connected with a Serial Clock line (SCL) and a Serial Data (SDA) line.

The register interface is configured to a generation of reading, writing and interruption of the registers in the process of accessing the optical module. The byte control module is configured to control a start bit command and a stop bit command in the process of accessing the optical module, and split a data bit command and a response bit command. The bit control module is configured to complete a sending time sequence and a receiving time sequence of each of commands, for example, completing sending and receiving time sequences of the start bit, the data bit, and the stop bit. The clock division module is configured to divide a high-frequency clock into target I2C clock signals, where the target I2C clock signal is a frequency of the clock signal required by the current I2C communication protocol, for example, completing the generation from the high-frequency clock to I2C sending clocks at frequencies such as 100 KHz or 400 KHz, and send the targe I2C clock signals to the bit control module.

As an implementation, the above byte control module may be configured to control the start bit command and the stop bit command by controlling a state machine to be in different states, and split the data bit command and the response bit command.

In some embodiments, the state machine may include an idle state, a start bit state, a stop bit state, and a response bit state. In a case where a current state of the state machine is not the idle state, that is, in a case where the state machine jumps to other states from the idle state, the stop bit state is jumped to in a case where the stop bit command is received; in a case where the start bit command is received, the start bit state is jumped to, and a corresponding byte operation is performed until a target bit is operated, and the response bit state is simultaneously jumped to; in a case where a response is completed, the stop bit state is jumped to, and the idle state is entered through the stop bit state; and in a case where the response is not completed, the idle state is jumped to.

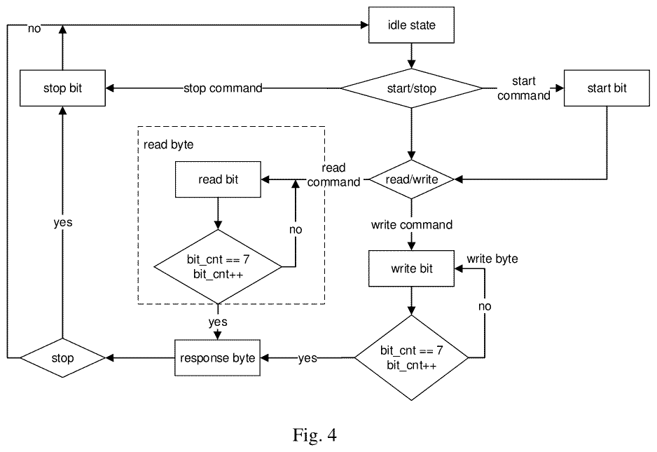

In some embodiments, the bit operation may include a bit read operation and a bit write operation. Accordingly, the state machine may further include a read bit state for performing reading byte and a write bit state for performing writing byte. The byte control module is further configured to enter a read bit state in response to receiving an optical module information reading command, and simultaneously count a total number of read bits; and jump to the response bit state in response to detecting a current total number of read bits to reach the target bit. The byte control module is further configured to enter the write bit state in response to receiving an optical module information write command, and simultaneously count a total number of write bits; and jump to the response bit state in response to detecting a current total number of write bits to reach the target bit. The target bit is determined according to the number of command bits. As shown in FIG. 4, the byte control module completes the splitting of 9 bit commands of the data bit and the response bit, then the target bit is 8, and bit_cnt represents a bit count, that is, the read byte reads a bit for 8 times, and then the response bit is jumped to; and the write byte writes the bit for 8 times, and then the response bit is jumped to.

Based on the structure of the communication control module, the flow of issuing the optical module information reading instruction in the CPU to the communication control module includes: an instruction is issued to the byte control module via the register interface, the start bit is first sent, the I2C extension chip device address write command is then sent, the write data command is sent, and 8-bit data is set to 1 corresponding to a channel bit, so as to open a channel of the optical module to be accessed correspondingly connected with the I2C extension chip device; then, according to a protocol format requirement acquired based on the optical module information, the start bit, the optical module address read command, the optical module register read command, the start bit, the optical module register read command, the data read command, and stop bit command sent after reading are sent; and finally, the start bit and the I2C extension chip device address write command are sent, and the write data 0 command is sent to close the channel. The flow of issuing the optical module information writing instruction in the CPU to the communication control module includes: an instruction is issued to the byte control module via the register interface, the start bit is first sent, the I2C extension chip device address write command is then sent, the write data command is sent, and 8-bit data is set to 1 corresponding to a channel bit, so as to open a channel of the optical module to be accessed correspondingly connected with the I2C extension chip device; then, according to a protocol format requirement acquired based on the optical module information, the start bit, the optical module address write command, the optical module register write command, the write data command, and the stop bit command are sent; and finally, the start bit and the I2C extension chip device address write command are sent, and the write data 0 command is sent to close the channel.

From the above, it may be learned that, in this embodiment, by using the communication control module to control the time sequence during I2C communication, access to the optical module may be realized.

In order to further improve the practicality of the optical module access system, implement large-scale I2C port extension, and support access to more optical modules, thereby realizing management of massive optical modules, based on the above embodiments, the communication control module 204 may include a plurality of control sub-modules; and each of the control sub-modules is connected with the address allocation module 202 and the interrupt module 205, respectively. Each of the control sub-modules is configured to access the corresponding optical module, based on the I2C communication protocol, according to an optical module address carried in the optical module access request issued by the CPU, and perform information feedback to the CPU by means of interrupt multiplexing.

In this embodiment, the interface function extension structure may include a plurality of programmable logic devices. Each of the programmable logic devices includes one communication control module, and the communication control module 204 may internally include a plurality of branches simultaneously to process the optical module access request, such that access and management on excessive optical modules may be realized simultaneously.

It may be understood that, a device is needed to divide the I2C bus into a plurality of sub-buses, and the interface function extension structure 2 is connected with each of the optical ports via one of the plurality of sub-buses, so as to expand limited I2C resources to enough interfaces. In this embodiment, the interface function extension structure 2 may be connected with the optical ports by using an I2C extension chip device, and two ends of the I2C extension chip device are respectively connected with the interface function extension structure and each of the plurality of optical ports via the I2C bus, so as to be connected with the optical module. The number of extension channels in the I2C extension chip device is determined based on a number of the programmable logic controllers 20 included in the interface function extension structure 2 and a total number of control sub-modules included in the communication control module 204, and each of the extension channels uniquely corresponds to one of the control sub-module. For example, the I2C extension chip device may be a set of I2C switch chips, such as a set of Pca954x (model) series chips. Only one control register exists in Pca954x, belonging to a device without sub-addresses. In a case where I/O access is performed, only a write operation needs to be performed to an address 0x00, so as to realize I2C bus selection for devices connected with PCA954x. The PCA9548 may implement 8 switches, thereby adding 8 I2C extension channels. In some application scenarios, accessing the optical modules may be achieved without an external I2C extension chip device, and the I2C extension chips may be replaced with high-capacity CPLD devices to accomplish I2C extension of all the optical modules. Those skilled in the art may flexibly perform selection based on actual situations, and none of these selections affect the implementation of this embodiment.

Inevitably, various faults occur when the system accesses the optical modules. In order to improve the reliability and stability of the system, based on the above embodiments, the present disclosure further provides an exemplary fault processing method, which may include the following content.

The interface function extension structure 2 is further configured to send a bus exception signal to the CPU in a case where an access exception is detected in the I2C bus connected with the target optical module via a target optical port. After the bus exception occurs, the CPU may directly send a write command and a stop command to the target optical module connected with the target optical port, so as to cause the target optical module to release the I2C bus. After notifying the CPU to send the bus access exception, the interface function extension structure may also send the write command and the stop command to the target optical module connected with the target optical port, so as to cause the target optical module to release the I2C bus.

In this embodiment, in a case where the bus access exception is detected, the CPU and the interface function extension structure 2 both may cause, by sending the write command and the stop command, the device to release the bus, thereby achieving a recovery function after the I2C communication protocol is suspended.

In order to further improve the performance of the system and reduce resource consumption caused by rotational training, based on the above embodiments, the interrupt multiplexing flow of the interface function extension structure 2, that is, the data processing flow of the interrupt module, may include the following content.

In response to being in the idle state, whether an interrupt signal exists is monitored, and the monitored interrupt signal is reported to the CPU. In a case where the interrupt signal is detected, an interrupt state is jumped to; and in a case where in the interrupt state, whether a current interrupt duration exceeds a preset interrupt threshold is determined. In a case where it that the current interrupt duration exceeds the preset interrupt threshold is determined, the idle state is jumped to; and in a case that the current interrupt duration does not exceed the preset interrupt threshold is determined, a response state is jumped to. In response to being in the response state, whether a current response time exceeds a preset response threshold is determined. In a case where the current response time exceeds the preset response threshold is determined, the idle state is jumped to; and in a case that the current response time does not exceed the preset response threshold is determined, the idle state is jumped to after the response is completed.

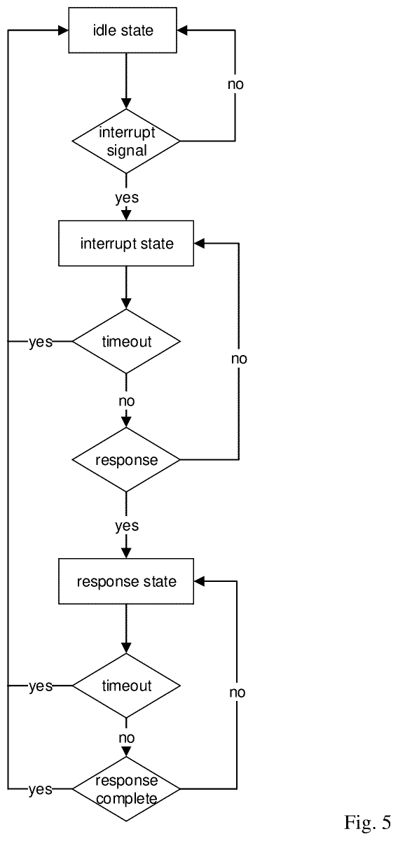

As shown in FIG. 5, the interrupt multiplexing process includes three states of the idle state, the interrupt state, and the response state. The idle state completes the operation of detecting the interrupt signals for the communication control module and each of the control sub-modules therein, and jumps to the interrupt state after the interrupt signal is detected. The interrupt state jumps to the idle state in a case where interrupt timeout is detected, and eliminates the interrupt signal state and jumps to the response state after interrupting a response. The response state jumps to the idle state in a case where timeout is detected, and after a state response is completed, jumps to the idle state and uses an interrupt detection and reporting functions again.

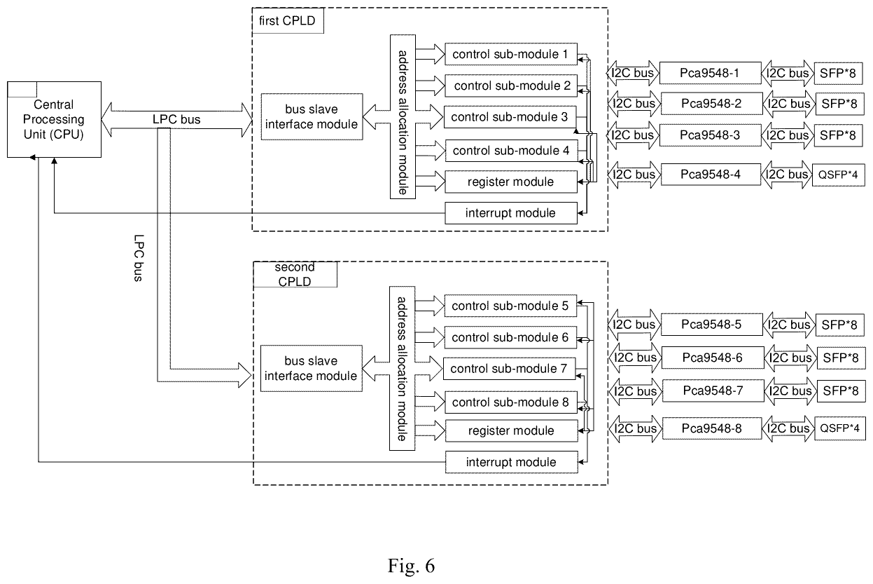

In order to make those skilled in the art better understand the technical solutions of the present disclosure, the present disclosure further provides an exemplary embodiment. A structure of the optical module access system in this embodiment is shown in FIG. 6. For example, the optical module access system may be applied to access to the optical module in the switch field or communication field. A programmable logic controller in this embodiment is a CPLD, and a target bus is an LPC bus, so as to expand the I2C port by using an LPC parallel interface bus on existing hardware, thereby achieving optical module management. In this embodiment, on the basis of original hardware, it only needs to connect the LPC bus to the port to manage the CPLD, I2C extension is completed by CPLD logic, and optical module access is completed by externally using the I2C extension chips. The entire system may be implemented based on a Lattice Machxo3LF 6900C (product model) chip, and the design language is Verilog. This embodiment may include the following content.

The optical module access system includes the CPU and the interface function extension structure. The interface function extension structure includes 2 CPLDs, and the CPU is connected with ports of the first CPLD and the second CPLD via the LPC bus. The first CPLD and the second CPLD are connected with a set of Pca9548 chips by providing the I2C buses. The set of Pca9548 chips of the first CPLD includes Pca9548-1, Pca9548-2, Pca9548-3, and Pca9548-4. The set of Pca9548 chips of the second CPLD includes Pca9548-5, Pca9548-6, Pca9548-7, and Pca9548-8. Each of the Pca9548 chips is correspondingly connected with 8 optical module interfaces SFP or four optical module interfaces QSFP. For example, the Pca9548-1 is connected with a SFP via an I2C bus, the Pca9548-2 is connected with a SFP via an I2C bus, the Pca9548-3 is connected with a SFP via an I2C bus, the Pca9548-4 is connected with a QSFP via an I2C bus, the Pca9548-5 is connected with a SFP via an I2C bus, the Pca9548-6 is connected with a SFP via an I2C bus, the Pca9548-7 is connected with a SFP via an I2C bus, and the Pca9548-8 is connected with a QSFP via an I2C bus.

In this embodiment, the CPU issues the optical module access request to the corresponding CPLD via the LPC bus, and the LPC of the CPLD receives the optical module access request from the interface. The CPLD may include the address allocation module, the communication control module, the register processing module, and the interrupt module. The communication control module includes 4 control sub-modules. The first CPLD includes a control sub-module 1, a control sub-module 2, a control sub-module 3, and a control sub-module 4. The second CPLD includes a control sub-module 5, a control sub-module 6, a control sub-module 7, and a control sub-module 8. The address allocation module acquires the optical module access request from the interface based on the LPC, and allocates addresses to the control sub-modules and the registers according to the control sub-modules included in the communication control module and the registers involved in the process of accessing the optical modules. The communication control module controls, based on the I2C communication protocol, the time sequence in the process of accessing the optical module. Throughout the entire process of accessing the optical module, the register processing module is used to complete the reading and writing of an interrupt register, a reset register, a test register. The interrupt module monitors the interrupt signal of each of the control sub-modules, and performs interrupt reporting and interrupt timeout processing to the CPU by means of interrupt multiplexing.

From the above, it may be learned that, in this embodiment, on the basis of original hardware, the CPLD connects an optical module management interface to a port management CPLD; the port management CPLD achieves I2C interface function extension based on an existing LPC management bus, so as to provide a unified interface to the upper-level software; and the upper-level software completes optical module management through the LPC. Flexible design, small hardware modification, good logical reusability, and low development costs are realized, and unified processing of the software is facilitated, then software processing complexity is reduced to reduce development difficulty and risks, thereby reducing operation costs, and achieving low-cost and high-efficiency optical module access.

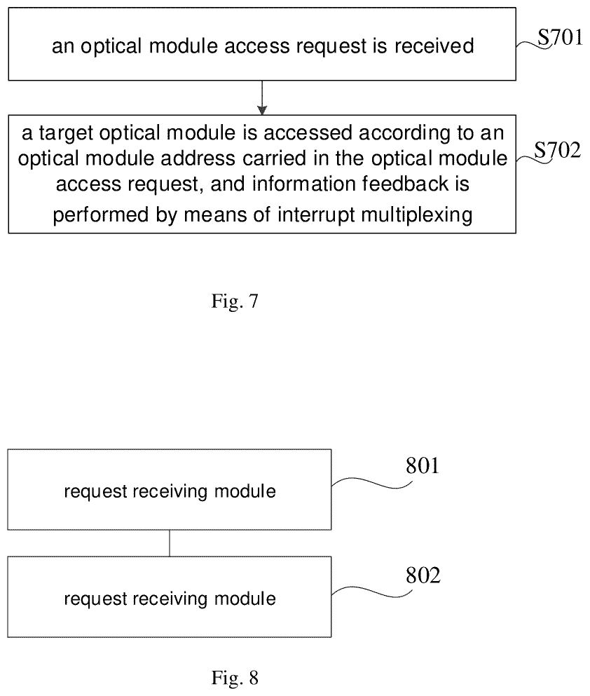

Based on the above embodiments, the present disclosure further provides an optical module access method applicable to the method described in any one of the above embodiments. Referring to FIG. 7, FIG. 7 is a schematic flowchart of an optical module access method according to the present disclosure. The present disclosure may include the following content.

### At S701, an Optical Module Access Request Is Received.

At S702, a target optical module is accessed according to an optical module address carried in the optical module access request, and information feedback is performed by means of interrupt multiplexing.

As an exemplary implementation of this embodiment, in a case where the optical module access request is an optical module information reading request, an implementation of S701 in the above embodiment of “accessing the target optical module according to the optical module address carried in the optical module access request” may include the following content.

A corresponding target extension channel in an I2C extension chip device is determined based on the optical module address, and the target extension channel is opened. A protocol format is acquired according to optical module information determined by an I2C communication protocol, an optical module information reading command is sent, and the target extension channel is closed after the optical module information is read.

The target extension channel is a path of the optical module required to read data for the optical module access request. As an implementation of the above embodiment, the manner of opening the target extension channel may include: first, the start bit is sent; and then, the I2C extension chip device address write command is sent, and the write data command is sent to open the target extension channel.

After the target extension channel is opened, the required optical module information may be read. As an implementation of the above embodiment, the process of sending the optical module information reading command may include: first, a start bit is sent, and then an optical module address read command and the optical module register read command are sent; the start bit is sent; the optical module register read command and an optical module data read command are sent; during the reading of the optical module information, whether the read operation is completed is detected in real time; and the stop bit command is sent in a case where the optical module information is read. In a case where the optical module information is read, in order to not affect subsequent optical modules to be accessed, the target extension channel also needs to be closed. As an implementation of the above embodiment, the manner of closing the target extension channel may include: first, the start bit is sent; and then, the I2C extension chip device address write command is sent, and the write data 0 command is sent to close the target extension channel. As another exemplary implementation of this embodiment, in a case where the optical module access request is an optical module information writing request, an implementation of S701 in the above embodiment of “accessing the target optical module according to the optical module address carried in the optical module access request” may include the following content.

The corresponding target extension channel in an I2C extension chip device is determined based on the optical module address, and the target extension channel is opened. The protocol format is acquired according to optical module information determined by the I2C communication protocol, the optical module information write command is sent, and the target extension channel is closed after the optical module information is written.

The target extension channel is a path of the optical module required to write data for the optical module access request. As an implementation of the above embodiment, the manner of opening the target extension channel may include: first, the start bit is sent; and then, the I2C extension chip device address write command is sent, and the write data command is sent to open the target extension channel.

After the target extension channel is opened, the required optical module information may be written to the optical module. As an implementation of the above embodiment, the process of sending the optical module information write command may include: first, the start bit is sent, and then the optical module address read command and the optical module register write command are sent; the optical module data write command is sent; during the writing of the optical module information, whether the data write operation is completed is detected in real time; and the stop bit command is sent in a case where the optical module information has been written. In a case where the optical module data has been written, in order to not affect subsequent optical modules to be accessed, the target extension channel also needs to be closed. As an implementation of the above embodiment, the manner of closing the target extension channel may include: first, the start bit is sent; and then, the I2C extension chip device address write command is sent, and the write data 0 command is sent to close the target extension channel.

The implementation process of the optical module access method in this embodiment may be implemented according to the content recorded in the above system embodiments. The implementation process may refer to the relevant descriptions in the above system embodiments and is not described herein again.

From the above, it may be learned that, this embodiment achieves low-cost and efficient access to the optical modules. It is to be noted that the steps in the present disclosure do not follow a strict sequential order, as long as they adhere to a logical sequence, these steps may be performed at the same time or according to a predetermined sequence. FIG. 7 is merely an illustrative representation and does not imply that this is the only possible execution order.

The present disclosure further provides a corresponding apparatus for the optical module access method, further causing the method to have practicality. The apparatus is described from both the functional module perspective and the hardware perspective. The optical module access apparatus configured in the present disclosure is introduced below. The apparatus is configured to implement the optical module access method configured in the present disclosure. In this embodiment, the optical module access apparatus may include or be divided into one or more program modules. The one or more program modules are stored in a non-transitory readable storage medium, and are performed by one or more processors to implement the optical module access method that has been disclosed in the above embodiments. The program modules in the present disclosure refer to a series of computer program instruction sections that can complete the specific functions, and are more suitable, than the program itself, for describing the execution process of the optical module access apparatus in the non-transitory readable storage medium. The functions of each program module in this embodiment are introduced below. The optical module access apparatus described below and the optical module access method described above may be correspondingly referenced to each other.

From the perspective of functional modules, referring to FIG. 8, FIG. 8 is a structure diagram of an optical module access apparatus according to an implementation of the present disclosure. The apparatus is applied to the optical module access system recorded in any one of the above embodiments. The apparatus may include a request receiving module and an optical module access module.

The request receiving module 801 is configured to receive an optical module access request. The optical module access module 802 is configured to access a target optical module according to an optical module address carried in the optical module access request, and perform information feedback by means of interrupt multiplexing.

In some implementations of this embodiment, the above optical module access module 802 may further be configured to perform the following operation.

A corresponding target extension channel in an I2C extension chip device is determined based on the optical module address, and the target extension channel is opened. A protocol format is acquired according to optical module information determined by an I2C communication protocol, an optical module information reading command is sent, and the target extension channel is closed after the optical module information is read.

As an implementation of the above embodiment, the above optical module access module 802 may further be configured to: send a start bit; and send an I2C extension chip device address write command, and send a write data command to open the target extension channel.

As another implementation of the above embodiment, the above optical module access module 802 may further be configured to: send the start bit; send an optical module address read command and an optical module register read command; send the start bit; and send the optical module register read command and an optical module data read command.

As still another implementation of the above embodiment, the above optical module access module 802 may further be configured to: send a stop bit command in a case where the optical module information is read; send the start bit; and send the I2C extension chip device address write command, and send a write data 0 command to close the target extension channel.

In some other implementations of this embodiment, the above optical module access module 802 may further be configured to perform the following operation.

The corresponding target extension channel in an I2C extension chip device is determined based on the optical module address, and the target extension channel is opened. The protocol format is acquired according to optical module information determined by the I2C communication protocol, the optical module information write command is sent, and the target extension channel is closed after the optical module information is written.

As an implementation of the above embodiment, the above optical module access module 802 may further be configured to: send the start bit; send an optical module address read command and an optical module register read command; send an optical module address read command and an optical module register write command; and send an optical module data write command.

Functions of functional modules in the optical module access apparatus of the present disclosure may be implemented according to the method in the above method embodiments, and for an implementation process, refer to related description of the above method embodiments, which are not described herein again.

From the above, it may be learned that, this embodiment may achieve low-cost and efficient access to the optical modules.

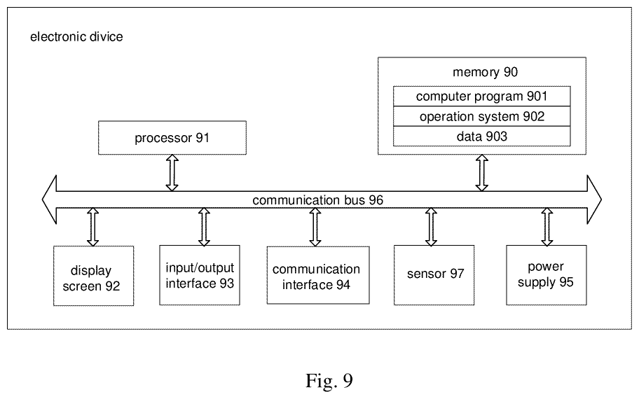

The optical module access apparatus mentioned above is described from the perspective of functional modules. Furthermore, the present disclosure further provides an electronic device, which is described from the hardware perspective. FIG. 9 is a schematic structural diagram of an electronic device according to an implementation of embodiments of the present disclosure. As shown in FIG. 9, the electronic device includes a memory 90 and a processor 91. The memory 90 is configured to store a computer program. The processor 91 is configured to implement, in response to performing the computer program, steps of the optical module access method mentioned in any one of the above embodiments.

The processor 91 may include one or more processing cores, for example, a 4-core processor or an 8-core processor. The processor 91 may also be a controller, a microcontroller, a microprocessor, other data processing chips, or the like. The processor 91 may be implemented by using at least one of the following hardware forms: digital signal processing (DSP), a field-programmable gate array (FPGA), or a programmable logic array (PLA). The processor 91 may also include a main processor and a coprocessor. The main processor is configured to process data in a wake-up state, which is also referred to as a central processing unit (CPU). The coprocessor is configured to process data in a standby state with low power consumption. In some embodiments, the processor 91 may be integrated with a graphics processing unit (GPU). The GPU is configured to render and draw content that needs to be displayed on a display screen. In some embodiments, the processor 91 may further include an artificial intelligence (AI) processor. The AI processor is configured to process computing operations related to machine learning.

The memory 90 may include one or more non-transitory storage media, and the non-transitory readable storage medium may be non-transient. The memory 90 may further include at least one high-speed random access memory and at least one non-transitory memory, for example, one or more disk storage devices and flash storage devices. The memory 90 may be an internal storage unit of the electronic device in some embodiments, for example, a hard disk of a server. In some other embodiments, the memory 90 may also be an external storage device of the electronic device, for example, a plug-in hard disk equipped on the server, a Smart Media Card (SMC), and a Secure Digital (SD) card, or a Flash Card. Further, the memory 90 may further include both the internal storage unit of the electronic device and the external storage device. The memory 90 can be configured not only to store application software and various types of data installed in the electronic device, for example, a code of a program during the performing of the optical module access method, but also to temporarily store data that has been output or will be output. In this embodiment, the memory 90 is at least configured to store the following computer program 901. After the computer program is loaded and executed by the processor 91, related steps of the optical module access method disclosed in any one of the above embodiments can be implemented. In addition, resources stored in the memory 90 may further include an operating system 902 and data 903, and a storage mode may be transient or permanent. The operating system 902 may include Windows, Unix, or Linux. The data 903 may include, but is not limited to, data corresponding to optical module access results.

In some embodiments, the above electronic device may further include a display screen 92, an input/output interface 93, a communication interface 94 (or referred to as a network interface), a power supply 95, and a communication bus 96. The display screen 92 and the input/output interface 93, for example, a keyboard, belong to user interfaces. In some embodiments, the user interfaces may also include a standard wired interface, or wireless interface. In some embodiments, the display may be a Light-Emitting Diode (LED) display, a liquid crystal display, a touch liquid crystal display, or an OLED touch device. The display can also be appropriately called a display screen or a display unit, and is configured to display the information processed in the electronic device and to display a visualized user interface. The communication interface 94 may include a wired interface and/or a wireless interface, such as a WI-FI interface and a Bluetooth interface., and is usually configured to establish a communication connection between the electronic device and other electronic devices. The communication bus 96 may be a Peripheral Component Interconnect (PCI) bus or an Extended Industry Standard Architecture (EISA) bus. The bus may be divided into an address bus, a data bus, and a control bus, and it's not limited to those. For ease of presentation, only one thick line is used in FIG. 9, but it does not mean that there is only one bus or one type of buses.

It may be understood by those skilled in the art that structures shown in FIG. 9 do not constitute limitations to the electronic device, and may include more or less components shown in the figures, for example, may also include a sensor 97 for implementing various functions.

Functions of functional modules in the electronic device of the present disclosure may be implemented according to the method in the above method embodiments, and for an implementation process, refer to related description of the above method embodiments, which are not described herein again.

From the above, it may be learned that, this embodiment may achieve low-cost and efficient access to the optical modules.

It is understandable that, if the optical module access method in the above embodiments is implemented in the form of the software functional unit and sold or used as an independent product, it can be stored in the computer non-transitory readable storage medium. Based on this understanding, the technical solutions of the present disclosure essentially or the parts that contribute to the related art, all or part of the technical solutions can be embodied in the form of a software product. The computer software product is stored in a non-transitory readable storage medium to execute all or part of the steps of the method described in the various embodiments of the present disclosure. The aforementioned non-transitory readable storage medium includes various non-transitory readable storage media capable of storing program codes such as a USB flash drive, a portable hard drive, a Read-Only Memory (ROM), a Random Access Memory (RAM), an Electrically Erasable Programmable ROM, register, a hard disk, a multimedia card, a card-type memory (for example, SD or DX memory), a magnetic memory, a removable disk, CD-ROM, a floppy disk, or an optical disc.

Based on this, the present disclosure further provides a non-transitory readable storage medium, storing a computer program. The above computer program implements, in respond to being executed by a processor, steps of the optical module access method described in any one of the above embodiments.

Each embodiment in this specification is described in a progressive manner, and each embodiment focuses on the differences from other embodiments, and the same or similar parts of each embodiment may be referred to each other. For the hardware disclosed in the embodiments including the apparatus and electronic device, since the apparatus corresponds to the method disclosed in the embodiments, the description is relatively simple, and for related parts, refer to the partial descriptions of the method.

The professional may further realize that the units and algorithmic steps of the various examples described in combination with the embodiments disclosed herein are capable of being implemented in electronic hardware, computer software, or a combination of electronic hardware and computer software. In order to clearly illustrate the interchangeability of hardware and software, the composition and the steps of the examples have been described in the above description in general terms according to functions. Whether these functions are executed in a hardware or software manner depends on specific applications and design constraints of the technical solutions. Professionals may realize the described functions for each specific application by use of different methods, but such implementation shall fall within the scope of the present disclosure.

The above optical module access method, apparatus and system, and electronic device and non-transitory readable storage medium configured in the present disclosure are introduced in detail. examples are used in this specification to describe the principles and implementations of the present disclosure. The description of the above examples is merely used to facilitate understanding of the core idea of the present disclosure. It should be noted that for those of ordinary skill in the art, without departing from the principles of the present disclosure, several improvements and modifications may be made to the present disclosure, which also fall within the scope of protection of the claims of the present disclosure.

1. An optical module access system, comprising a processor and an interface function extension structure, wherein the interface function extension structure comprises a plurality of controllers, and the processor is connected with a port of each of the plurality of controllers via a target bus;
the processor is configured to issue an optical module access request to the interface function extension structure via the target bus; and
each of the plurality of controllers of the interface function extension structure is connected with a plurality of optical modules via a plurality of Inter-Integrated Circuit (I2C) buses, and is configured to access a target optical module according to an optical module address carried in the optical module access request, and to perform information feedback to the processor by means of interrupt multiplexing.

2. The optical module access system as claimed in claim 1, wherein a controller comprises a bus salve interface module, an address allocation module, a register processing module, a communication control module, and an interrupt module;
the address allocation module is connected with the bus salve interface module, the register processing module, and the communication control module, respectively; the interrupt module is connected with the processor and the communication control module, respectively;
the bus salve interface module is configured to analyze read and write commands of the target bus, and convert analyzed read and write commands into read and write commands in a target format; the address allocation module is configured to allocate addresses to the communication control module and the register processing module; the register processing module is configured to perform read and write processing on each of registers in a process of accessing the optical module; the communication control module is configured to control a time sequence in the process of accessing the optical module; and the interrupt module is configured to perform information reporting to the processor by means of interrupt multiplexing.

3. The optical module access system as claimed in claim 2, wherein the communication control module comprises a register interface, a byte control module, a bit control module, and a clock division module;
the register interface is connected with the byte control module, the bit control module, and the clock division module, respectively; the byte control module is connected with the bit control module; the clock division module is connected with the bit control module; the bit control module is connected with I2C buses;
the register interface is configured to complete a generation of reading, writing and interruption of the registers in the process of accessing the optical module; the byte control module is configured to control a start bit command and a stop bit command in the process of accessing the optical module, and split a data bit command and a response bit command; the bit control module is configured to complete a sending time sequence and a receiving time sequence of each of commands; and the clock division module is configured to divide a high-frequency clock into target I2C clock signals, and send the target I2C clock signals to the bit control module.

4. The optical module access system as claimed in claim 3, wherein the byte control module is configured to control the start bit command and the stop bit command by controlling a state machine to be in different states, and to split the data bit command and the response bit command.

5. The optical module access system as claimed in claim 4, wherein the byte control module is further configured to:
in a case where a current state of the state machine is not an idle state, jump to a stop bit state in response to receiving the stop bit command;
in response to receiving the start bit command, jump to a start bit state, and perform a corresponding byte operation until a target bit is operated, and simultaneously jump to a response bit state; in a case where a response is completed, jump to the stop bit state; and in a case where the response is not completed, jump to the idle state.

6. The optical module access system as claimed in claim 5, wherein the byte control module is configured to enter a read bit state in response to receiving an optical module information reading command, and simultaneously count a total number of read bits; and
jump to the response bit state in response to detecting a current total number of read bits to reach the target bit;
or, the byte control module is configured to enter a write bit state in response to receiving an optical module information write command, and simultaneously count a total number of write bits; and
jump to the response bit state in response to detecting a current total number of write bits to reach the target bit.

7. (canceled)

8. The optical module access system as claimed in claim 2, wherein the communication control module comprises a plurality of control sub-modules; each of the plurality of control sub-modules is connected with the address allocation module and the interrupt module, respectively;
each of the plurality of control sub-modules is configured to access a corresponding optical module according to an optical module address carried in an optical module access request issued by the processor, and to perform information feedback to the processor by means of interrupt multiplexing.

9. The optical module access system as claimed in claim 2, wherein the target bus is a Low Pin Count (LPC) bus; and the bus salve interface module is configured to complete an IO read and write function of the LPC bus.

10. The optical module access system as claimed in claim 1, wherein the interface function extension structure is connected with each of the plurality of optical modules via an I2C extension chip device; two ends of the I2C extension chip device are respectively connected with the interface function extension structure and each of the plurality of optical modules via an I2C bus; and
a number of extension channels in the I2C extension chip device is determined based on a number of the plurality of controllers comprised in the interface function extension structure and a total number of control sub-modules comprised in the communication control module, and each of the extension channels uniquely corresponds to one of the control sub-modules.

11. The optical module access system as claimed in claim 10, wherein the interface function extension structure comprises a plurality of complex devices; and
one end of each of the plurality of complex devices is connected with the processor via the target bus, and the other end is connected with the I2C extension chip device via an I2C bus.

12. The optical module access system as claimed in claim 1, wherein the interface function extension structure is further configured to send a bus exception signal to the processor in a case where an access exception is detected in an I2C bus connected with the target optical module.

13. The optical module access system as claimed in claim 12, wherein the processor is further configured to send a write command and a stop command to the target optical module, causing the target optical module to release the I2C bus.

14. The optical module access system as claimed in claim 12, wherein the interface function extension structure is further configured to send a write command and a stop command to the target optical module, causing the target optical module to release the I2C bus.

15. The optical module access system as claimed in claim 1, wherein the interface function extension structure is further configured to:
in response to being in an idle state, monitor whether an interrupt signal exists, and report a monitored interrupt signal to the processor;
in response to detecting the interrupt signal, jump to an interrupt state; in response to being in the interrupt state, determine whether a current interrupt duration exceeds a preset interrupt threshold;
in response to determining that the current interrupt duration exceeds the preset interrupt threshold, jump to the idle state; in response to determining that the current interrupt duration does not exceed the preset interrupt threshold, jump to a response state;
in response to being in the response state, determine whether a current response time exceeds a preset response threshold;
in response to determining that the current response time exceeds the preset response threshold, jump to the idle state; and in response to determining that the current response time does not exceed the preset response threshold, jump to the idle state after the response is completed.

16. An optical module access method, applied to an optical module access system, wherein the optical module access system comprises a processor and an interface function extension structure;
the interface function extension structure comprises a plurality of controllers, and the processor is connected with a port of each of the plurality of controllers via a target bus;
the processor is configured to issue an optical module access request to the interface function extension structure via the target bus; and
each of the plurality of controllers of the interface function extension structure is connected with a plurality of optical modules via a plurality of Inter-Integrated Circuit (I2C) buses, and is configured to access a target optical module according to an optical module address carried in the optical module access request, and to perform information feedback to the processor by means of interrupt multiplexing;
and the optical module access method comprises:
receiving an optical module access request; and
accessing a target optical module according to an optical module address carried in the optical module access request, and performing information feedback by means of interrupt multiplexing.

17. The optical module access method as claimed in claim 16, wherein accessing the target optical module according to the optical module address carried in the optical module access request comprises:
determining a corresponding target extension channel in an Inter-Integrated Circuit (I2C) extension chip device based on the optical module address, and opening the target extension channel; and
acquiring a protocol format according to optical module information determined by an I2C communication protocol, sending an optical module information reading command, and closing the target extension channel after the optical module information is read.

18. The optical module access method as claimed in claim 17, wherein opening the target extension channel comprises:
sending a start bit; and
sending an I2C extension chip device address write command, and sending a write data command, to open the target extension channel;
or, sending the optical module information reading command comprises:
sending a start bit;
sending an optical module address read command and an optical module register read command;
sending the start bit; and
sending the optical module register read command and an optical module data read command;
or, closing the target extension channel after the optical module information is read comprises:
sending a stop bit command in a case that the optical module information is read;
sending a start bit; and
sending an I2C extension chip device address write command, and sending a write data 0 command, to close the target extension channel.

19. (canceled)

20. (canceled)

21. The optical module access method as claimed in claim 16, wherein accessing the target optical module according to the optical module address carried in the optical module access request comprises:
determining a corresponding target extension channel in an I2C extension chip device based on the optical module address, and opening the target extension channel; and
acquiring a protocol format according to optical module information determined by an I2C communication protocol, sending an optical module information write command, and closing the target extension channel after the optical module information is written.

22. The optical module access method as claimed in claim 21, wherein sending the optical module information write command comprises:
sending a start bit;
sending an optical module address read command and an optical module register write command; and
sending an optical module data write command.

23. (canceled)

24. An electronic device, comprising a processor and a memory, wherein the processor is configured to, in response to executing a computer program stored in the memory, implement steps of an optical module access method, and the optical module access method comprises:
receiving an optical module access request; and
accessing a target optical module according to an optical module address carried in the optical module access request, and performing information feedback by means of interrupt multiplexing.

25. (canceled)
